(19) United States
(12) Patent Application Publication
(10) Pub. No.: US 2025/0319704 A1
(43) Pub. Date: Oct. 16, 2025

(54) RECORDING APPARATUS, IMAGE PROCESSING METHOD, RECORDING APPARATUS AND STORAGE MEDIUM

(71) Applicant: CANON KABUSHIKI KAISHA, Tokyo (JP)

(72) Inventors: TATSUO SHIMMOTO, Tokyo (JP); NOBORU KUNIMINE, Tokyo (JP)

(21) Appl. No.: 19/169,948

(22) Filed: Apr. 3, 2025

(30) Foreign Application Priority Data
Apr. 15, 2024 (JP) 2024-065813

(51) Int. Cl. B41J 2/21; B41J 11/00

(52) U.S. Cl. CPC B41J 2/2114; B41J 11/0015

(57) ABSTRACT

The among of application of a reagent in a case where a lamination processing mode is set is determined to be greater than the amount of application of a reaction liquid in a case where the lamination processing mode is not set, whereby adhesion to a laminate layer is improved.

### BACKGROUND

### Field of the Disclosure

The present disclosure relates to a recording apparatus configured to record an image on a recording medium, an image processing method, a recording apparatus, and a storage medium.

### Description of the Related Art

Inkjet recording apparatuses that record an image on a recording medium by applying ink to the recording medium are known. In recent years, such inkjet recording apparatuses are expected to produce recorded products with less visible bleeding. When an image is recorded using a plurality of types of ink, an image defect known as “bleeding”, which is referred to as a bleeding phenomenon, may occur at a boundary between inks with different color materials. A technique using reaction liquid that reacts with color materials contained in color material inks has been known to reduce the bleeding phenomenon. By bringing the color material inks and the reaction liquid into contact with each other on a recording medium, the color materials contained in the color material inks aggregate, which reduces bleeding.

Japanese Patent Application Laid-Open No. 2002-321349 discusses a technique for reducing bleeding by gradually increasing the amount of a reaction liquid to be applied based on the amount of a color material ink applied to a recording medium.

Through the investigation by the inventors, it was found that in lamination processing as post-processing, there may be an issue that adhesion between a laminate layer and a surface layer of an ink layer on a recorded product decreases.

This issue may be increasingly noticeable in a case where a color material ink contains a lubricant, such as wax particles. To ensure the fastness of an ink layer on a recorded product, it is desirable to improve the slipperiness of a surface layer of the ink layer. However, the inclusion of the lubricant in the surface layer of the ink layer may reduce adhesion to the laminate layer.

### SUMMARY

In addressing the above-described issue, the present disclosure is directed to appropriately setting the application amount of a reaction liquid.

According to an aspect of the present disclosure, a recording apparatus including a recording unit including a plurality of recording elements configured to apply a color material ink containing a color material to a recording medium and a plurality of recording elements configured to apply, to the recording medium, a reaction liquid containing a component that causes the color material contained in the color material ink to aggregate, a controlling unit configured to control an operation of applying the color material ink and the reaction liquid by the recording unit, an acquiring unit configured to acquire information indicating whether to perform lamination processing on the recording medium on which an image has been recorded, and a determining unit configured to determine an application amount of the reaction liquid based on the information and an application amount of the color material ink for each pixel.

Further features of the present disclosure will become apparent from the following description of exemplary embodiments with reference to the attached drawings.

### BRIEF DESCRIPTION OF THE DRAWINGS

FIG. 1 is a perspective view illustrating a recording apparatus.

FIG. 2 is a cross-sectional view illustrating the recording apparatus.

FIG. 3 is a schematic diagram illustrating a recording head.

FIG. 4 is a schematic diagram illustrating a recording control system.

FIG. 5 is a flowchart illustrating recording data generation.

FIG. 6 is an explanatory diagram illustrating multi-pass recording.

FIG. 7 is a conceptual diagram illustrating a cold lamination processing apparatus.

FIGS. 8A and 8B are schematic diagrams illustrating a decrease in the proportion of the lubricant presence with an increase in the application amount of a reagent.

FIG. 9 is a flowchart illustrating an image data process of an image processing system.

FIG. 10 is a diagram illustrating a user interface (UI) screen for setting the presence or absence of a lamination processing mode.

FIG. 11 is a diagram illustrating a relationship between the application amount of color material inks and the application amount of a reagent.

FIGS. 12A to 12C are schematic diagrams illustrating a distribution process of color material inks and a reaction liquid and binary RCT data in the presence and absence of the lamination processing mode setting.

FIGS. 13A and 13B are side views schematically illustrating variations of the range of non-recorded regions on a recording medium which occurs in accordance with the recording medium type, in a predetermined region with a small application amount of color material inks.

FIGS. 14A and 14B are diagrams illustrating a relationship between the application amount of color material inks and the application amount of a reagent.

### DESCRIPTION OF THE EMBODIMENTS

A first exemplary embodiment of the present disclosure will be described below with reference to the drawings.

### (Configuration of Recording Apparatus)

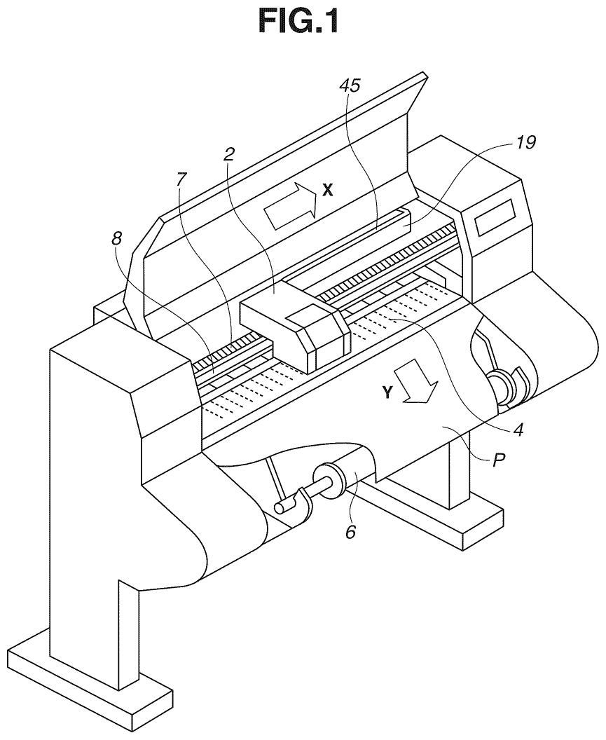

FIG. 1 is a perspective view illustrating an inkjet recording apparatus according to the present exemplary embodiment. The inkjet recording apparatus according to the present exemplary embodiment is a so-called serial scanning printer. A recording head 9 moves in a scanning direction (X-direction in FIG. 1) perpendicular to a conveyance direction (Y-direction in FIG. 1) in which a recording medium P is conveyed, whereby an image is recorded on the recording medium P.

An overview of the configuration and operation of the inkjet recording apparatus during recording will be described below. A conveyance motor (not illustrated) drives a conveyance roller via a gear, and a spool 6 conveys the recording medium P in the conveyance direction. A guide shaft 8 extends in the X-direction. A carriage unit 2 is driven by a carriage motor (not illustrated) to scan. In a predetermined recording region, the carriage unit 2 performs reciprocally scan along the guide shaft 8. The recording head 9 is attached to the carriage unit 2. During scanning by the carriage unit 2, ink is ejected from the recording head 9 at a timing based on a position signal acquired by an encoder 7, and applied in droplets onto the recording medium P. A plurality of ejection openings is disposed in the recording head 9, and each ejection opening includes a recording element configured to convert electrical energy into energy for ink ejection. In the present exemplary embodiment, the recording element is an electrothermal conversion element, and the recording head 9 is a so-called thermal inkjet recording head.

In a single scan by the carriage unit 2 carrying the recording head 9, an image is recorded in a region (hereinafter, also referred to as “band”) with a width corresponding to the arrangement range of the ejection openings. In the present exemplary embodiment, an application operation to eject ink is performed at a scanning speed of 40 inches per second at a recording resolution of 1200 dpi ( 1/1200-inch intervals). After completion of the single scan, the recording medium P is conveyed, and the next scan is performed. Scanning is also performable at speeds exceeding 40 inches per second.

A carriage belt may be used to transmit driving force from the carriage motor to the carriage unit 2. Instead of the carriage belt, a different driving method, such as a method with a lead screw extending in the Y-direction and driven and rotated by the carriage motor and an engagement portion disposed to the carriage unit 2 and engaging with a groove of the lead screw is also employable.

The recording medium P is held between a feed roller and a pinch roller and conveyed to a recording region where the recording head 9 on a platen 4 performs recording. In the absence of an image recording job, an ejection opening surface where the ejection openings of the recording head 9 are disposed is covered with a cap. In a case where a recording instruction is received, the cap is opened, and an initial operation is started to prepare the recording head 9 and the carriage unit 2 for scanning. In a case where data for a single scan is stored in a buffer, the carriage unit 2 is moved, and the recording operation is performed.

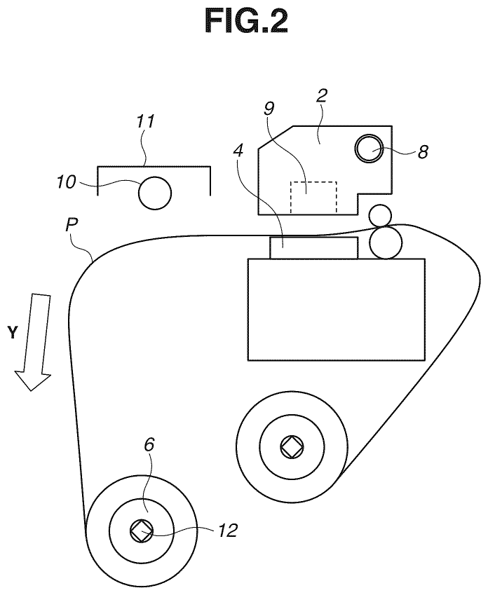

FIG. 2 is a cross-sectional view illustrating the recording apparatus. A heater 10 supported by a frame (not illustrated) is disposed in a curing region and dries ink in liquid form on the recording medium P by using heat. The curing region is at a position downstream in a sub-scanning direction X from the position where the recording head 9 attached to the carriage unit 2 performs reciprocally scan in a main scanning direction Y. The heater 10 is covered with a heater cover 11, and the heater cover 11 functions to efficiently transfer heat from the heater 10 to the recording medium P and protect the heater 10. After being recorded by the recording head 9, the recording medium P is wound onto a winding spool 12 in a roll of the winding medium (spool) 6. Specific examples of the heater 10 include a sheathed heater and a halogen heater. A heating temperature of a heating portion in the curing region is set factoring in the film-forming properties and productivity of a water-soluble resin emulsion and the heat resistance of the recording medium P. Examples of a method used by a heating unit in the heating portion in the curing region include heating by blowing warm air from above and contact heating with a heat conductive heater from beneath the recording medium P. While a single heating unit is disposed at one position in the heating portion in the curing region in the present exemplary embodiment, heating units may be provided at two or more positions and used in combination.

The recording apparatus according to the present exemplary embodiment performs so-called multi-pass recording in which an image is recorded in a predetermined region (1/n band) on the recording medium P by performing n scans (where n is an integer greater than or equal to two) of the recording head 9. Details of this multi-pass recording will be described below.

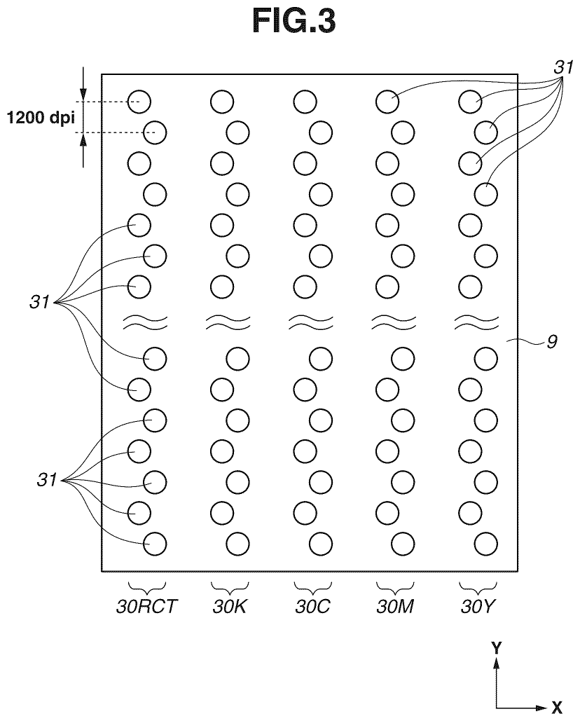

FIG. 3 is a diagram illustrating the recording head 9 according to the present exemplary embodiment. The recording head 9 includes ejection opening arrays 30K, 30C, 30M, and 30Y. The ejection opening arrays 30K, 30C, 30M, and 30Y respectively eject black ink (K), cyan ink (C), magenta ink (M), and yellow ink (Y) as inks containing color materials.

Since the black ink (K), the cyan ink (C), the magenta ink (M), and the yellow ink (Y) each contain a color material, the inks will be referred to also as color material inks, for simplicity.

The recording head 9 includes an ejection opening array 30RCT to eject a reaction liquid (RCT) containing no color materials. The reaction liquid does not contain color materials but contains a reagent that reacts with the color materials contained in the color material inks, and the reaction liquid comes into contact with the color material inks on the recording medium P to reduce bleeding.

While four types of color material inks (K, C, M, Y) are included as color material inks in the present exemplary embodiment, this is not a limitation, and a light ink, such as light cyan ink (Lc) or light magenta ink (Lm), may be included. Further, gray ink (GY) as another light ink may be included as a color material ink. Further, a specialty ink, such as green ink (G), orange ink (OR), red ink (R), or blue ink (B), may be included.

In the recording head 9, the ejection opening arrays 30RCT, 30K, 30C, 30M, and 30Y are arranged in this order from left to right in the X-direction.

The ejection opening arrays 30RCT, 30K, 30C, 30M, and 30Y each include 1,280 ejection openings 31 arranged in the Y-direction (conveyance direction) with a density of 1200 dpi and configured to eject the corresponding ink. In the present exemplary embodiment, each of the ejection openings 31 ejects approximately 6 pl of ink at a time.

Each of the ejection opening arrays 30RCT, 30K, 30C, 30M, and 30Y is connected to an ink tank (not illustrated) that stores the corresponding ink, and the inks are supplied. The recording head 9 and the ink tanks used in the present exemplary embodiment may either be integrally configured or each may be configured to be separable.

Detailed ink compositions of the black ink (K), the cyan ink (C), the magenta ink (M), the yellow ink (Y), and the reaction liquid (RCT) will be described below.

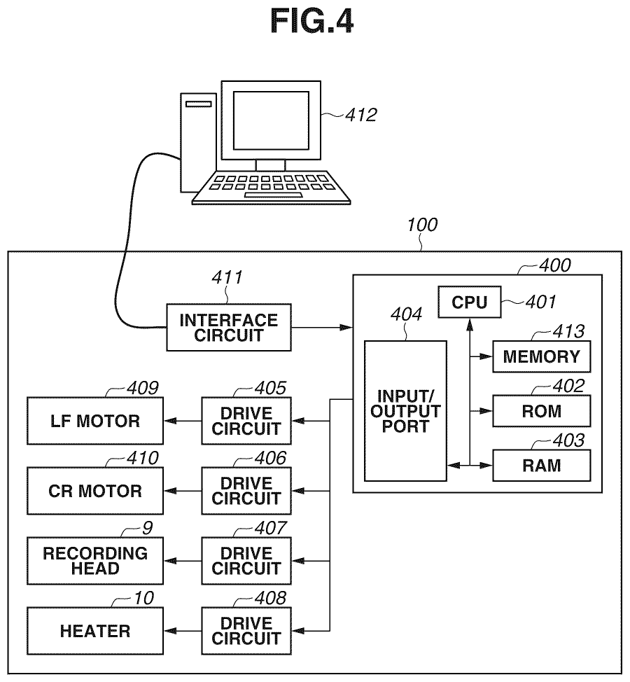

FIG. 4 is a schematic diagram illustrating a recording control system in a recording apparatus 100 according to the present exemplary embodiment. A main control unit 400 includes a central processing unit (CPU) 401, a read-only memory (ROM) 402, a random access memory (RAM) 403, and an input/output port 404. The CPU 401 executes processing operations, such as arithmetic, selection, discrimination, and control processing operations, and a recording operation. The ROM 402 stores control programs to be executed by the CPU 401. The RAM 403 is used as a buffer for recording data. A memory 413 stores mask patterns described below. Drive circuits 405, 406, 407, and 408 for a conveyance motor (LF motor) 409, a carriage motor (CR motor) 410, the recording head 9, the heater 10, and an actuator in a disconnection unit are connected to the input/output port 404. The main control unit 400 is connected to a host personal computer (host PC) 412 via an interface circuit 411.

### (Data Generation)

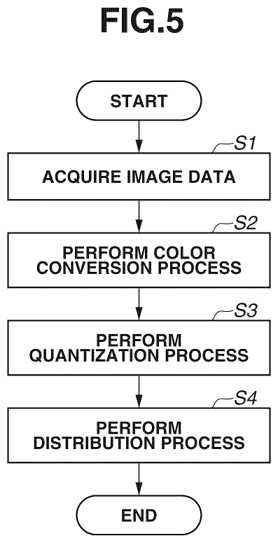

FIG. 5 is a flowchart illustrating a recording data generation process performed by the CPU 401 based on a control program. In step S1, image data (luminance data) represented by information consisting of 8-bit 256 values (0 to 255) for each of red (R), green (G), and blue (B) input to the recording apparatus 100 is acquired from the host PC 412, which is a host computer.

In step S2, color conversion is performed to convert the image data represented by R, G, and B into multivalued data represented by the plurality of types of inks (K, C, M, Y, and RCT) that is used in recording. This color conversion process generates multivalued data defining the tones of each of the K, C, M, Y, and RCT inks for each pixel group composed of a plurality of pixels. The multivalued data is data of 8-bit 256 values (0 to 255).

In step S3, quantization is performed on the multivalued data represented by K, C, M, Y, and RCT to generate quantized data (binary data) represented by 1-bit binary information (0, 1) defining for each pixel whether each of the K, C, M, Y, and RCT inks is to be ejected or not ejected.

The quantization process may be performed based on various quantization methods, such as an error diffusion method, a dither method, or an index method.

In step S4, a distribution process is performed to distribute the quantized data across a plurality of scans covering a predetermined region with the recording head 9. The distribution process generates 1-bit binary (0, 1) recording data for each pixel in each of the plurality of scans covering the predetermined region on the recording medium P. The recording data is generated for each of K, C, M, Y, and RCT and defines whether to eject or not eject each ink. The distribution process is for the plurality of scans and is performed using a mask pattern that defines whether each ink is allowed to be ejected to each pixel.

The inks are ejected from the recording head 9 based on the recording data generated by the above-described processes to record an image on the recording medium P.

While the CPU 401 in the recording apparatus 100 performs the processes of steps S1 to S4, this is not a limitation. For example, the host PC 412 may perform all of the processes of steps S1 to S4. Alternatively, the host PC 412 may perform some of the processes, and the recording apparatus 100 may perform the rest.

### (Multi-pass Recording Method)

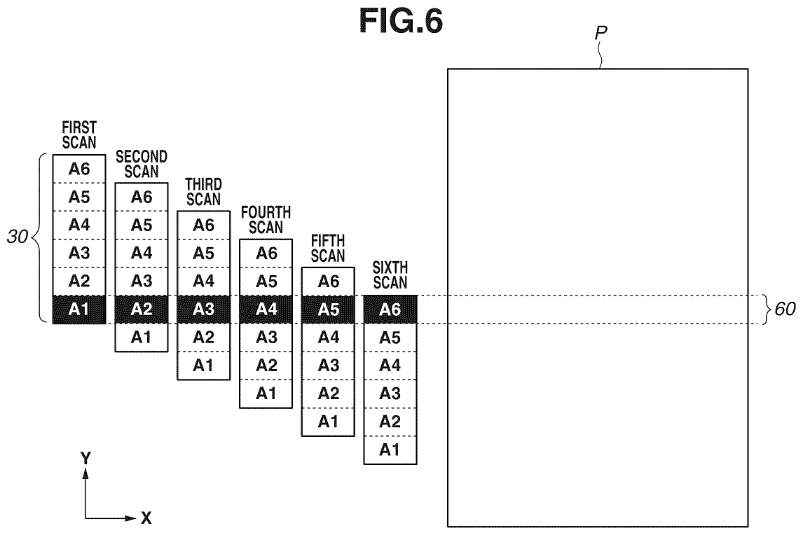

In the present exemplary embodiment, so-called multi-pass recording is performed. In multi-pass recording, an image is recorded in a predetermined region on the recording medium P in a plurality of scans using the K, C, M, Y, and RCT inks. The multi-pass recording will be described below with reference to FIG. 6.

FIG. 6 is an explanatory diagram illustrating a multi-pass recording method. As described above, an image is recorded in the predetermined region on the recording medium P in n scans (where n is an integer of 2 or greater) of the recording head 9. In FIG. 6, n=6. Ejection opening groups A1 to A6 each include a respective one-sixth of ejection openings of ejection opening array 30 in the Y-direction (conveyance direction). The ejection opening groups A1 to A6 respectively correspond to the six scans over the predetermined region. While the recording medium P is conveyed downstream in the Y-direction between scans of the recording head 9, FIG. 6 illustrates the recording head 9 being moved upstream in the Y-direction between scans, for simplicity.

In the first scan, a predetermined region 60 on the recording medium P is at a position facing the ejection opening group A1 in the ejection opening array 30. The ejection opening group A1 is driven relative to the predetermined region 60, and ink is ejected, based on the recording data corresponding to the first scan. After the first scan is finished, the recording medium P is conveyed in the Y-direction by a distance corresponding to a single ejection opening group.

Similarly, the second scan is performed. The ejection opening group A2 is driven relative to the predetermined region 60, and ink is ejected. Thereafter, the ejection operations from the ejection opening groups A3 to A6 in the third to sixth scans over the predetermined region 60 are performed by alternately performing the conveyance of the recording medium P and the ejection operation from the recording head 9. As a result, the image recording on the predetermined region 60 is completed.

While n=6 in FIG. 6, this is not a limitation, and an image may be recorded in more than six scans. In this case, the length of the predetermined region in the Y-direction is shorter than the length of the predetermined region 60 in the Y-direction in FIG. 6.

An image may be recorded in fewer than six scans. In this case, the length of the predetermined region in the Y-direction is longer than the length of the predetermined region 60 in the Y-direction.

### (Overview of Ink Composition)

Details of each ink of an ink set that is used in the present exemplary embodiment will be described below. Hereinafter, unless otherwise specified, “parts” and “%” are by mass.

### 1. Ink Composition

The compositions of the inks will be described in detail below. The color material inks (K, C, M, Y) and the reaction liquid (RCT) that is used in the present exemplary embodiment each contain a water-soluble organic solvent. Due to the wettability and moisture retention properties of the surface of the recording head 9, the water-soluble organic solvent desirably has a boiling point of 150° C. or higher and 300° C. or lower. Particularly, a ketone compound, such as acetone or cyclohexanone, a propylene glycol derivative, such as tetraethylene glycol dimethyl ether, or a heterocyclic compound with a lactam structure exemplified by N-methyl-pyrrolidone and 2-pyrrolidone is desirable from the perspective of the function of a film-forming auxiliary agent with respect to fine resin particles and the swelling and solubility in the recording medium P with a resin layer formed thereon. From the perspective of ejection performance, the content of the water-soluble organic solvent is preferably 3 wt % or higher and 30 wt % or lower. Specific examples of water-soluble organic solvents include alkyl alcohols with 1 to 4 carbon atoms, such as methyl alcohol, ethyl alcohol, n-propyl alcohol, isopropyl alcohol, n-butyl alcohol, sec-butyl alcohol, and tert-butyl alcohol, amides, such as dimethylformamide and dimethylacetamide, ketones or ketoalcohols, such as acetone and diacetone alcohol, ethers, such as tetrahydrofuran and dioxane, polyalkylene glycols, such as polyethylene glycol and polypropylene glycol, ethylene glycol, alkylene glycols containing alkylene groups with 2 to 6 carbon atoms, such as propylene glycol, butylene glycol, triethylene glycol, 1,2,6-hexanetriol, thioglycol, hexylene glycol, and diethylene glycol, lower alkyl ether acetate, such as polyethylene glycol monomethyl ether acetate, glycerin, lower alkyl ethers of polyhydric alcohols, such as ethylene glycol monomethyl (or ethyl) ether, diethylene glycol methyl (or ethyl) ether, and triethylene glycol monomethyl (or ethyl) ether, polyhydric alcohols, such as trimethylolpropane and trimethylolethane, N-methyl-2-pyrrolidone, 2-pyrrolidone, and 1,3-dimethyl-2-imidazolidinone. The above-described water-soluble organic solvents may be used alone or as a mixture. It is desirable to use deionized water as water. The water-soluble organic solvent content in the reaction liquid (RCT) is not particularly limited. An antifoam agent, a preservative, and/or a mildew inhibitor may be added to the color material inks (K, C, M, Y), in addition to the above-described components, to impart a desired physical property value as necessary.

The color material inks (K, C, M, Y) and the reaction liquid (RCT) that is used in the present exemplary embodiment each contain a surfactant. The surfactant is used to improve the wetting and spreading properties of the inks on the recording medium P. Increase in the added amount of the surfactant increases the property of reducing the surface tension of the inks, which improves the wetting and spreading properties of the inks on the recording medium P. In the present exemplary embodiment, a small amount of an acetylene glycol ethylene oxide (EO) adduct is added as a surfactant to make adjustments so that each ink has a static surface tension of 30 dyn/cm or lower and, furthermore, the difference in static surface tension between color material inks remains within 2 dyn/cm. More specifically, each color material ink is adjusted to have a static surface tension of approximately 22 dyn/cm to 24 dyn/cm. A fully automated surface tensiometer CBVP-Z (manufactured by Kyowa Interface Science Co., Ltd.) is used to measure the static surface tension of the inks. This is not a limiting example, and any measurement device that measures the static surface tension of the inks is usable.

The pH of every color material ink in the present exemplary embodiment remains stable in the alkali range, and its value is 8.5 to 9.5. The pH of each color material ink is desirably 7.0 or higher and 10.0 or lower from the perspective of preventing elution and degradation of components that come into contact with the color material inks in the recording apparatus 100 and the recording head 9 and a decrease in the solubility of the resin dispersed in the color material inks. A PH meter F-52 manufactured by HORIBA, Ltd. is used to measure the pH. This is not a limiting example, and any measurement device that measures the pH of the inks is usable.

### 2. Water-Soluble Resin Emulsion

The color material inks used in the present exemplary embodiment contain a water-soluble resin emulsion. The term “water-soluble resin emulsion” refers to polymer fine particles that exist in a dispersed state in water. Specific examples include acrylic resin fine particles synthesized by emulsion polymerization of a monomer, such as (meth)acrylic acid alkyl ester and (meth)acrylic acid alkyl amide, styrene-acrylic resin fine particles synthesized by emulsion polymerization of (meth)acrylic acid alkyl ester or (meth)acrylic acid alkyl amide with a styrene monomer, polyethylene resin fine particles, polypropylene resin fine particles, polyurethane resin fine particles, and styrene-butadiene resin fine particles. Other examples include core-shell type resin fine particles with the core and the shell composed of different polymer compositions and fine particles obtained by using pre-synthesized acrylic-based fine particles as seed particles and performing emulsion polymerization around them to control the particle size. Yet other examples include hybrid-type resin fine particles chemically bonded from different types of resin fine particles, such as acrylic resin fine particles and urethane resin fine particles.

### 3. Lubricant

The color material inks used in the present exemplary embodiment contain a lubricant. The term “lubricant” refers to wax particles or silicone-based surfactants. Specific examples of wax particles include synthetic wax particles, such as Fischer-Tropsch wax (EMUSTAR-6315) manufactured by NIPPON SEIRO CO., LTD. and polyolefin wax (high-tech E-9500) manufactured by TOHO Chemical Industry Co., Ltd., and natural wax particles, such as carnauba wax (Cerosol 524) manufactured by CHUKYO YUSHI CO., LTD. and paraffin wax (AQUACER 497) manufactured by BYK Japan KK. Further, silicone oil is also usable as a lubricant, and examples include a polyether-modified silicone (BYK 333) manufactured by BYK Japan KK.

### 4. Reaction Liquid

In the present exemplary embodiment, a system of recording using a reaction liquid to make some or all of the solid components in the color material inks insoluble to solve image issues, such as bleeding and beading, is employed as necessary.

Examples of a reagent of the reaction liquid for making dissolved dyes or dispersed pigments and resins insoluble include multivalent metal ions (e.g., magnesium sulfate, magnesium nitrate, magnesium chloride, emulsified calcium, aluminum sulfate, iron chloride). As one type of such aggregation effect using cations, a system using a low molecular weight cationic polymer coagulant to neutralize the charge of the water-soluble resin emulsion and make anionic soluble substances insoluble is also usable.

Further, another example of a reaction system is an insolubilization system using a reaction liquid that utilizes a pH difference.

As described above, most color material inks for use in inkjet recording are generally stable in the alkali range due to the properties of the color materials, and the pH is generally 7.0 or higher and 10.0 or lower. In many cases, the pH is typically set around 8.5 to 9.5 considering industrial perspectives and the influence of external environmental factors. In order to aggregate and solidify the color material inks in such a system, an acidic solution is introduced to change the pH, which disrupts the stable state and promotes the aggregation of dispersed components. For the purpose of such an effect, a solution that exhibits acidic properties is also usable as a reaction liquid.

### (Recording Medium)

In the present exemplary embodiment, a low-absorbency recording medium P having a low absorb moisture property is used. The low-absorbency recording medium P refers to a medium that has no water absorbency or absorbs very little water. In a case where an aqueous ink without organic solvents is used on such a medium, the ink is repelled, which prevents image formation. On the other hand, the medium is excellent in water resistance and weather resistance, and the medium is suitable for forming recorded products intended for outdoor use. Normally, a recording medium with a water contact angle of 45° or greater, desirably 60° or greater, at 25° C. is used.

The low-absorbency recording medium P is a recording medium with a plastic layer formed on the outermost surface of its substrate, a recording medium without ink receiving layers on its substrate, a glass, Yupo, or plastic sheet or film, or a banner. Examples of the coated plastic include polyvinyl chloride, polyethylene terephthalate, polycarbonate, polystyrene, polyurethane, polyethylene, and polypropylene. With excellent water resistance, light resistance, and abrasion resistance, the low-absorbency recording media P are commonly used to form recorded products intended for outdoor display.

### (Lamination Processing)

In general, lamination processing on a recorded product is performed by a lamination processing apparatus separate from the recording apparatus 100. After an image is recorded on a recording medium P by the recording apparatus 100, the recording medium P is wound by the winding spool 12 illustrated in FIG. 2 to obtain the roll of winding medium 6. Then, the winding medium 6 is transported into the lamination processing apparatus, and a sheet-type laminate film is bonded to the recording medium P and then cut to match the size of the recording medium P.

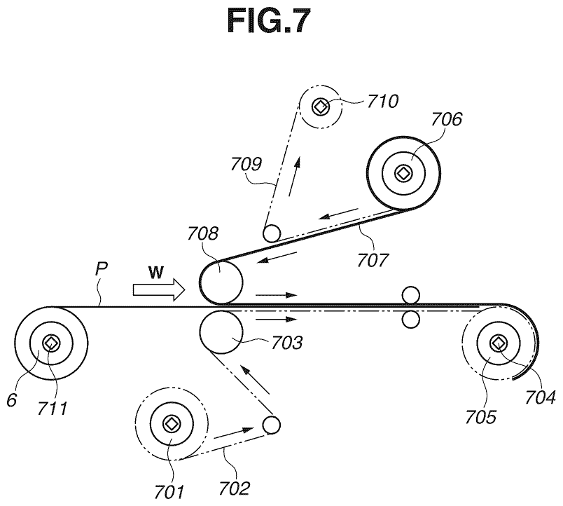

FIG. 7 is a conceptual diagram illustrating a cold lamination processing apparatus that is used in the present exemplary embodiment. A winding spool 704 winds a waste film 702 from a waste film roll 701 disposed at a lower portion of the cold lamination processing apparatus via a lower-side pressing roller 703.

Similarly, the winding spool 704 winds a laminate film 707 from a laminate film roll 706 disposed at an upper portion of the cold lamination processing apparatus via an upper-side pressing roller 708. As a result, a roll-wound medium 705 is obtained.

In this processing, a release liner 709 of the laminate film 707 is wound by a winding spool 710. Thus, an adhesive portion of the laminate film 707 is exposed before the laminate film 707 is conveyed to the upper-side pressing roller 708. The laminate film 707 with the exposed adhesive portion and the waste film 702 are conveyed while being respectively pressed by the upper-side pressing roller 708 and the lower-side pressing roller 703, forming the roll-wound medium 705.

Here, the recording medium P recorded by the recording apparatus 100 is attached to an attachment spool 711 of the cold lamination processing apparatus. Then, the recording medium P is conveyed in a W-direction (conveyance direction), passed between the lower-side pressing roller 703 and the upper-side pressing roller 708, and wound also by the winding spool 704. As a result, the laminate film 707 with the exposed adhesive and the recording medium P are bonded together to form the roll-wound medium 705 which has been subjected to lamination processing.

Besides cold lamination, lamination processing using a general-purpose lamination processing apparatus or a lamination processing apparatus dedicated to hot lamination with an oriented polypropylene (OPP) film or a polyethylene terephthalate (PET) film is also performable. Examples include a method using a synthetic resin, such as acrylic, and a method of coating or spraying the surface layer of the ink layer with a coating liquid containing a weather resistance-enhancing agent, such as an ultraviolet (UV) absorber or an antioxidant, and UV-curable components in the resin.

While the present exemplary embodiment describes an example of using the lamination processing apparatus separate from the recording apparatus 100, this is not a limitation. The recording apparatus 100 may be integrated with the lamination processing apparatus.

### (Relationship Between Lamination Processing and Amount of Reaction Liquid)

In the present exemplary embodiment, the proportion of the lubricant present on the surface layer of the ink layer on the recorded product differs between the case where a lamination processing mode is set and the case where the lamination processing mode is not set. With this configuration, the adhesion of the laminate layer, such as a laminate film, to the surface layer of the ink layer on the recorded product is increased.

The application amount of the reaction liquid for the same type of recording medium is changed based on whether the lamination processing mode for the recorded product is set by the user. Specifically, the application amount of the reaction liquid is adjusted to be greater in the case where the lamination processing mode is set than in the case where the lamination processing mode is not set.

The proportion of the lubricant present on the surface layer of the ink layer will be described below. The distribution of the lubricant present in a thickness direction of the ink layer is measured, and the amount of the lubricant present within a depth of 100 um or less from the outermost layer of the ink layer in a case where the amount of the lubricant in the entire thickness of the ink layer is normalized to 100% is calculated. In an example of a method for evaluating the proportion of the lubricant present, normalization is performed using time-of-flight secondary ion mass spectrometry (TOF-SIMS) with detected intensity integral values of lubricant components, and then the proportion of the lubricant present is calculated.

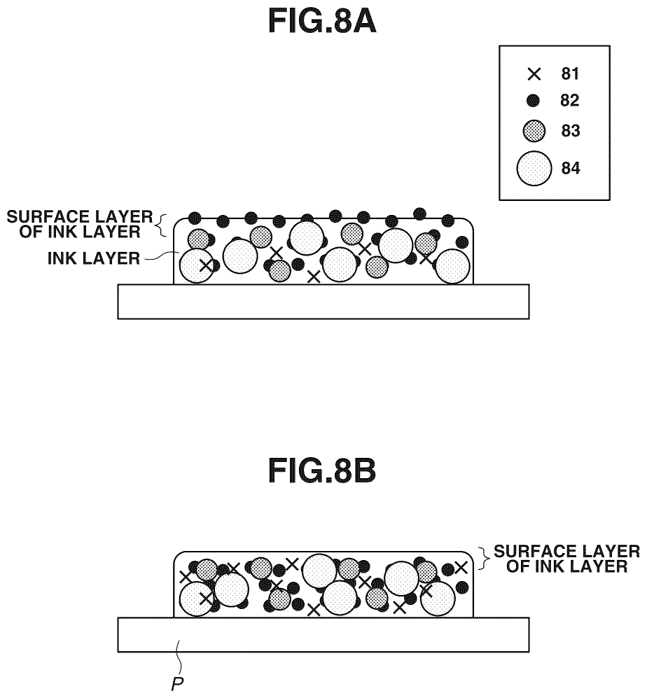

FIGS. 8A and 8B are schematic diagrams illustrating the proportion of the lubricant present on the surface layer of the ink layer on the same recording medium P with and without the lamination processing mode setting. FIG. 8A illustrates a case where the lamination processing mode is not set, and FIG. 8B illustrates a case where the lamination processing mode is set.

The applied color material inks and the applied reaction liquid on the recording medium P are aqueous inks. Thus, they are hardly absorbed into the low-absorbency recording medium P and remain on the recording medium P. As illustrated in FIG. 8A, in the case where the lamination processing mode is not set, a reagent 81 contained in the reaction liquid and a lubricant 82, a color material 83, and a water-soluble resin emulsion 84 contained in the color material inks are present in the ink layer. Here, the application amount of the reaction liquid relative to the application amount of the color material inks does not exceed the amount sufficient to reduce bleeding. In this case, the proportion of the lubricant 82 present in the surface layer of the ink layer is high. In other words, the slipperiness of the surface layer of the ink layer is high, ensuring the fastness of the ink layer on the recorded product. However, the lubricant 82 present in the surface layer of the ink layer also acts as an inhibiting factor that reduces adhesion of the surface layer of the ink layer to the laminate layer.

Thus, in the case where the lamination processing mode is set, the application amount of the reaction liquid is increased relative to the case where the lamination processing mode is not set. This increases the amount of the reagent 81 in the ink layer. As illustrated in FIG. 8B, the proportion of the lubricant 82 in the surface layer of the ink layer decreases, and the lubricant 82 has sunk into the ink layer. As a result, adhesion to the laminate layer improves.

### (Image Processing System)

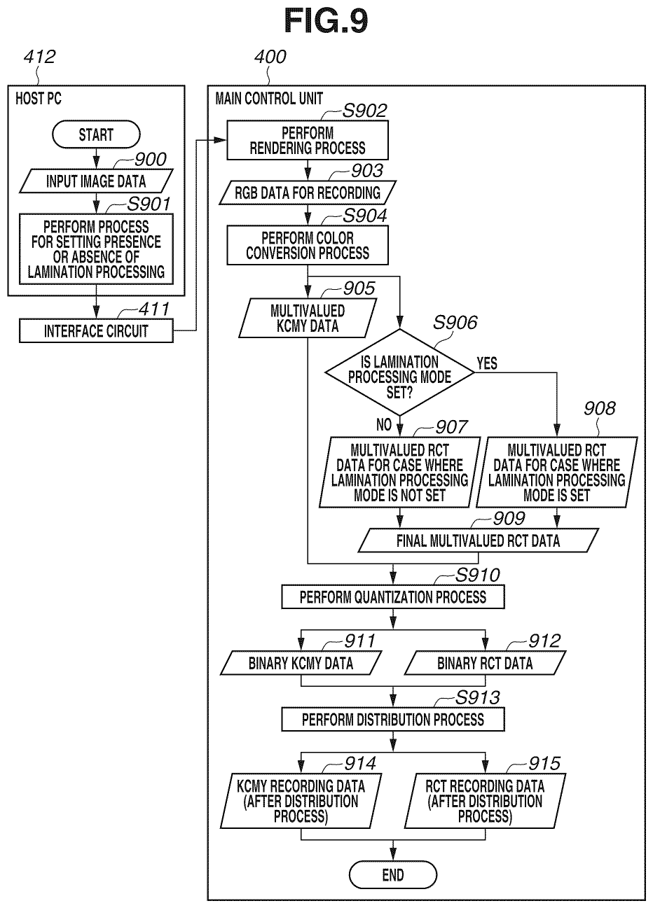

FIG. 9 is a flowchart illustrating an image data process of an image processing system including the recording apparatus 100 and the host PC 412 in the present exemplary embodiment. The host PC 412 in which a printer driver is installed performs a process for setting the presence or absence of lamination processing on input image data 900. In step S901, a lamination processing mode setting process is performed. The main control unit 400 of the recording apparatus 100 performs image processing on the input image data 900 transferred from the host PC 412 via the interface circuit 411.

In step S902, the main control unit 400 performs a rendering process on the input image data 900 at a resolution of 1200 dpi. As a result, multivalued RGB data 903 for recording is generated.

In the present exemplary embodiment, the multivalued RGB data 903 for recording is 256-value data. In step S904, a color conversion process is performed to convert the multivalued RGB data 903 for recording into 256-value KCMY data and 256-value RCT data.

In step S906, a determination process is performed to determine whether the lamination processing mode is set by the user in step S901. In a case where the lamination processing mode is not set (NO in step S906), multivalued RCT data 907 for the case where the lamination processing mode is not set in step S901 is generated. In a case where the lamination processing mode is set (YES in step S906), multivalued RCT data 908 for the case where the lamination processing mode is set in step S901 is generated. The multivalued RCT data 907 or 908 generated in the determination process in step S906 serves as final multivalued RCT data 909.

In step S910, a quantization process, such as an error diffusion process, is performed to quantize multivalued (256-value) KCMY data 905 generated in the color conversion process in step S904 and the final multivalued RCT data 909. As a result, binary KCMY data 911 and binary RCT data 912 at a resolution of 1200 dpi are generated.

In step S913, a distribution process is performed to distribute the binary KCMY data 911 and the binary RCT data 912 across a plurality of scans covering the predetermined region with the recording head 9. The distribution process generates KCMY recording data 914 represented by 1-bit binary information (0, 1) defining whether to eject or not eject each of the K, C, M, and Y inks for each pixel in each of the plurality of scans covering the predetermined region on the recording medium P. Simultaneously, RCT recording data 915 represented by 1-bit binary information (0, 1) defining whether to eject or not eject the RCT ink for each pixel in each of the plurality of scans covering the predetermined region on the recording medium P is generated. The distribution process in step S914 corresponds to the plurality of scans and is performed using a mask pattern that defines whether each ink is allowed to be ejected to each pixel.

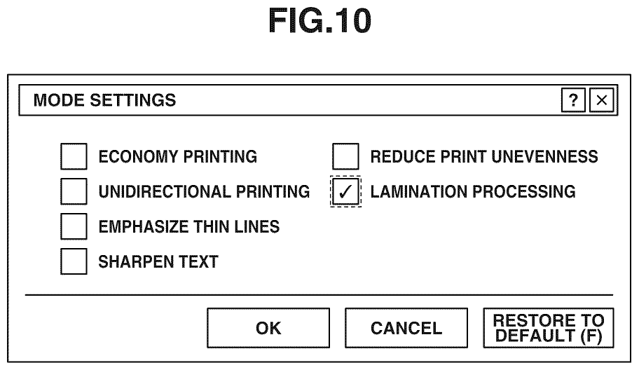

An example of the process for setting the presence or absence of lamination processing for the input image data 900 by the user in step S901 is a user interface (UI) screen displayed on a monitor of the host PC 412 in FIG. 10. In a case where a checkbox for “lamination processing” is checked, the result of the determination process in step S906 is “YES”. On the other hand, in a case where the checkbox for “lamination processing” is not checked, the result of the determination process in step S906 is “NO”. While, in the present exemplary embodiment, the UI screen displayed on the monitor of the host PC 412 is used, this is not a limitation, and, for example, an operation unit disposed to the recording apparatus 100 may be used.

### (Reaction Liquid Application Amount Determination Method)

In the present exemplary embodiment, in a case where the lamination processing mode is set, the color conversion process in step S904 generates multivalued RCT data for the case where the lamination processing mode is set.

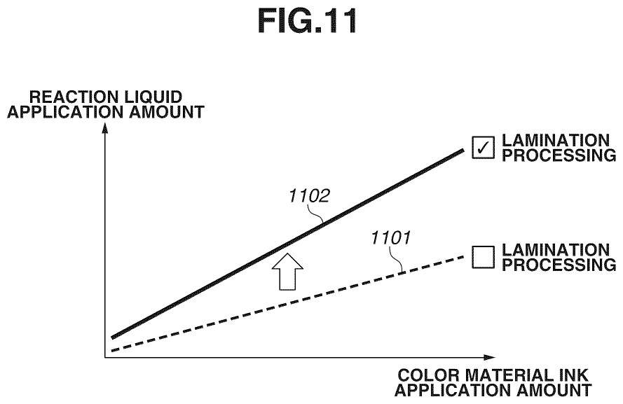

FIG. 11 is a diagram illustrating a relationship between the application amount of the color material inks and the application amount of the reaction liquid in the present exemplary embodiment. In FIG. 11, the horizontal axis represents the color material ink application amount, and the vertical axis represents the reaction liquid application amount. The color material ink application amount represented by the horizontal axis is the total amount of the color material inks to be applied to a predetermined region. In the present exemplary embodiment, it is the total amount of the KCMY inks. A line 1101 represents the relationship between the color material ink application amount and the reaction liquid application amount in the case where the lamination processing mode is not set. A line 1102 represents the relationship between the color material ink application amount and the reaction liquid application amount in the case where the lamination processing mode is set. In the present exemplary embodiment, the slope of the line 1102 is twice the slope of the line 1101. Specifically, the reaction liquid application amount at a certain color material ink application amount in the case where the lamination processing mode is set is 2A, where A is the reaction liquid application amount at the color material ink application amount in the case where the lamination processing mode is not set. While, in the present exemplary embodiment, the reaction liquid application amount in the case where the lamination processing mode is set is twice the reaction liquid application amount in the case where the lamination processing mode is not set, this is not a limiting value, and any amount that improves the adhesion strength of a recorded product to a laminate layer is employed.

### (Recording Control)

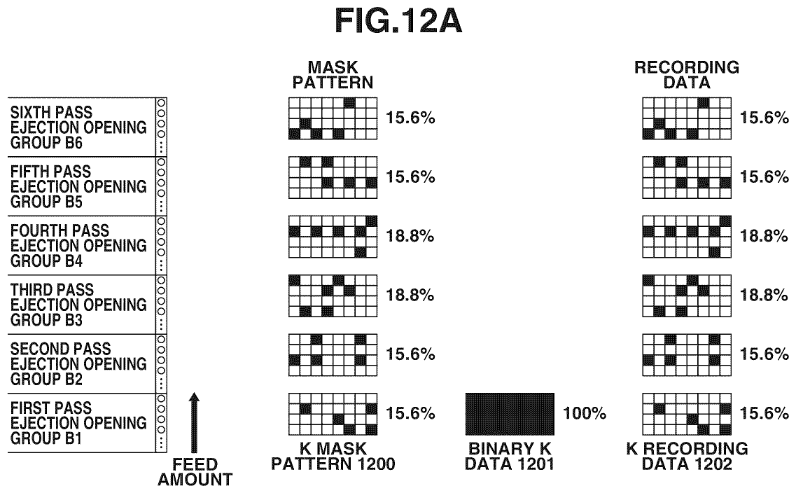

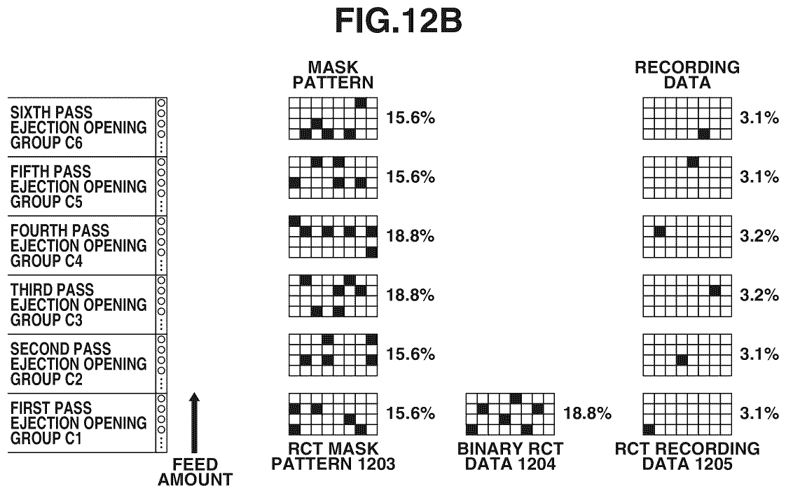

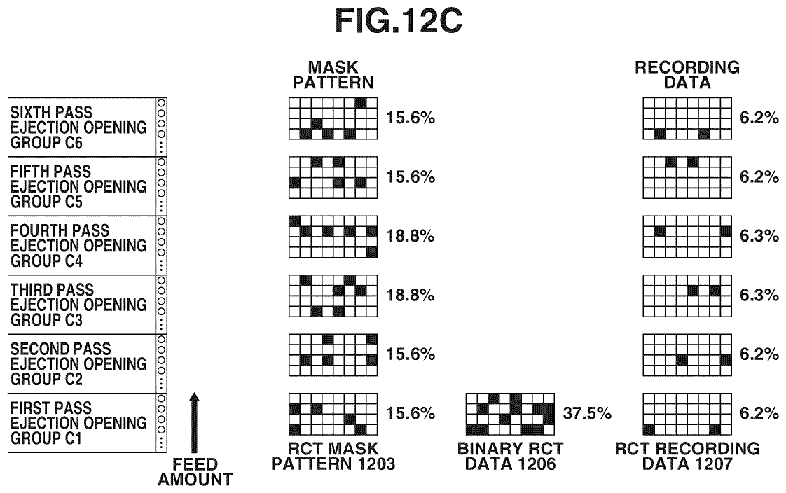

FIGS. 12A to 12C are schematic diagrams illustrating a process of distributing the color material inks and the reaction liquid and final binary RCT data in the presence and absence of the lamination processing mode setting in the present exemplary embodiment.

FIG. 12A illustrates a mask pattern group that is applied to quantized data corresponding to the ejection opening array 30K for the black ink. FIG. 12B illustrates a mask pattern group that is applied to quantized data corresponding to the ejection opening array 30RCT for the reaction liquid in the case where the result of the determination process in step S906 is “NO”. FIG. 12C illustrates a mask pattern group that is applied to quantized data corresponding to the ejection opening array 30RCT for the reaction liquid in the case where the result of the determination process in step S906 is “YES”. In FIGS. 12A to 12C, each black pixel represents a recording-allowed pixel where ink ejection is allowed, and each white pixel represents a recording-not-allowed pixel where ink ejection is not allowed.

In FIG. 12A, a mask pattern that is applied to the quantized data for black ink is illustrated as a mask pattern that is applied to quantized data for color material ink. Mask patterns that are applied to quantized data for cyan, magenta, and yellow inks are also set similarly.

In a mask pattern 1200 for the black ink in FIG. 12A, recording-allowed pixels are arranged at mutually exclusive and complementary positions. The total recording allowance rate of the mask pattern 1200 is 100%. In a case where, for example, quantized data 1201 defining ink ejection for 100% (=32/32×100) of the pixels is input as quantized data for black ink, the total number of pixels for which ink ejection is defined is also 100% in recording data 1202 corresponding to the first to sixth scans and generated using the mask pattern 1200 illustrated in FIG. 12A. In other words, the application amount of the black ink is kept before and after the distribution process.

Also in a mask pattern 1203 for the reaction liquid in FIG. 12B, recording-allowed pixels are arranged at mutually exclusive and complementary positions. The total recording allowance rate of the mask pattern 1203 is 100%. In a case where, for example, quantized data defining ink ejection for 18.8% (=6/32×100) of the pixels is input as quantized data 1204 for the reaction liquid, the total number of pixels for which ink ejection is defined is also 18.8% in recording data 1205 corresponding to the first to sixth scans and generated using the mask pattern 1203 illustrated in FIG. 12B.

The mask pattern 1203 for the reaction liquid in FIG. 12C is the same as the mask pattern 1203 for the reaction liquid in FIG. 12B. The ratio of recording-allowed pixels is higher in quantized data 1206 corresponding to the reaction liquid in the case where the result of the determination process in step S906 is “YES” than in the quantized data 1204 corresponding to the reaction liquid in the case where the result of the determination process in step S906 is “NO”. In a case where, for example, quantized data defining ink ejection for 37.5% (=12/32×100) of the pixels is input, the total number of pixels for which ejection is defined is also 37.5% in recording data 1207 corresponding to the first to sixth scans and generated using the mask pattern 1203 illustrated in FIG. 12C.

While 18.8% and 100% are respectively set for the pixels in the reaction liquid recording data in the case where the result of the determination process in step S906 is “NO” and the pixels in the black ink recording data in the present exemplary embodiment, this is not a limitation, and any percentage that can reduce the bleeding phenomenon in the recorded product is settable.

In the first exemplary embodiment, the method of increasing the application amount of the reaction liquid based on whether the lamination processing mode is set is uniform regardless of the application amount of the color material inks. In contrast, in a second exemplary embodiment, the rate of increase in the application amount of the reaction liquid is changed based on the application amount of the color material inks. Redundant descriptions of those that are similar to the first exemplary embodiment is omitted.

As described above, the issue to be addressed is low adhesion of the recorded product to the laminate layer. However, this issue less likely occurs in regions with a small application amount of the color material inks on the recorded product. This is considered to be due to the following two factors. The first factor is that the application amount of the lubricant that may act as a main inhibiting factor that reduces adhesion of the surface layer of the ink layer to the laminate layer is small due to the small application amount of the color material inks. The second factor is that the adhesion of non-recorded regions without color material inks on the recording medium, i.e., blank regions, to the laminate layer is high. In the regions with a small application amount of the color material inks, the contribution of the non-recorded regions with high adhesion to the laminate layer increases.

Considering the foregoing factors, the rate of increase in the application amount of the reaction liquid is changeable based on the application amount of the color material inks in determining the application amount of the reaction liquid based on whether the lamination processing mode is set. Specifically, the rate of increase in the application amount of the reaction liquid based on whether the lamination processing mode is set is set lower in regions with a small application amount of the color material inks than in regions with a large application amount of the color material inks. With this configuration, the consumption of the reaction liquid is reduced compared to the configuration described in the first exemplary embodiment.

It is known that the occupancy rate of blank regions in regions with a small application amount of the color material inks varies because the wetting and spreading properties of the color material inks vary with recording medium type. Thus, the adhesion of regions with a small application amount of the color material inks to the laminate layer varies with recording medium type.

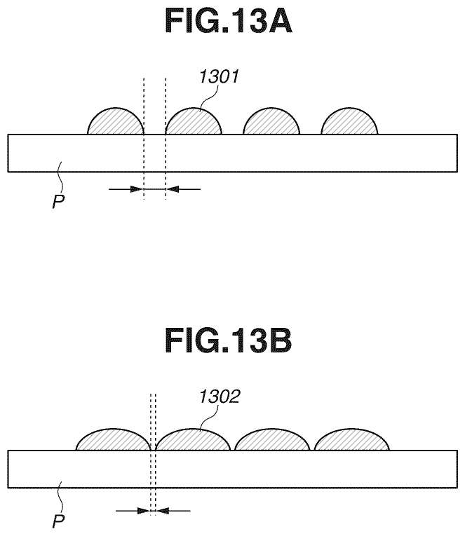

FIGS. 13A and 13B are schematic diagrams illustrating a range of a blank region in a region with a small application amount of the color material inks on the recording medium P. FIG. 13A illustrates a case using the recording medium P of a type having smooth surfaces on the blank regions and reducing wetting and spreading properties of isolated dots 1301 of the color material inks. FIG. 13A shows that the occupancy rate of blank regions with high adhesion to the laminate layer is high. The adhesion of the recording medium P of this type to the laminate layer is high in regions with a small application amount of the color material inks. On the other hand, FIG. 13B illustrates a case using the recording medium P of a type having smooth surfaces on blank regions but increasing wetting and spreading properties of isolated dots 1302 of the color material inks. FIG. 13B shows that the occupancy rate of blank regions with high adhesion to the laminate layer is low. The adhesion of the recording medium P of this type to the laminate layer is low in regions with a small application amount of the color material inks.

### (Method for Increasing Application Amount of Reaction Liquid)

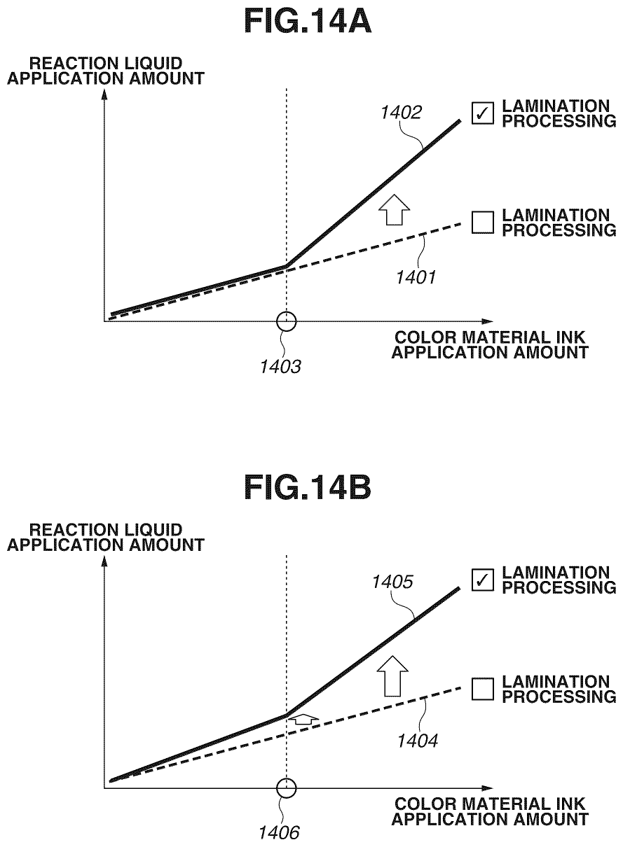

FIGS. 14A and 14B are graphs illustrating the application amount of the reaction liquid relative to the application amount of the color material inks that is used in a process of generating binary RCT additional data. As described above, the rate of increase in the application amount of the reaction liquid based on whether the lamination processing mode is set is lower in regions with a small application amount of the color material inks than in regions with a large application amount of the color material inks. The rate of increase in the application amount of the reaction liquid in regions with a small application amount of the color material inks based on whether the lamination processing mode is set is further changed based on the recording medium type.

For the recording medium type illustrated in FIG. 13A, the relationship between the application amount of the color material inks and the application amount of the reaction liquid in FIG. 14A is used. On the other hand, for the recording medium type illustrated in FIG. 13B, the relationship between the application amount of the color material inks and the application amount of the reaction liquid in FIG. 14B is used. A line 1401 represents the relationship between the application amount of the color material inks and the application amount of the reaction liquid on the recording medium illustrated in FIG. 13A in the case where the lamination processing mode is not set by the user. Here, the application amount of the reaction liquid is greater than or equal to an amount that is sufficient to reduce at least bleeding and beading with respect to the application amount of the color material inks. On the other hand, a line 1402 represents the relationship between the application amount of the color material inks and the application amount of the reaction liquid in the case where the lamination processing mode is set by the user. Here, in regions where the application amount of the color material inks is greater than a threshold 1403, the application amount of the reaction liquid is increased relative to the application amount of the reaction liquid specified by the line 1401. On the other hand, in regions where the application amount of the color material inks is less than the threshold 1403, the application amount of the reaction liquid approximately equal to the line 1401 is set.

As described above, since the adhesion of the regions with a small application amount of the color material inks on the recording medium illustrated in FIG. 13A to the laminate layer is high, increase in the application amount of the reaction liquid is avoidable. Thus, the application amount of the reaction liquid is set less than that in the first exemplary embodiment, which reduces the consumption of the reaction liquid. Details of the threshold 1403 will be described below.

The application amount of the reaction liquid specified by the line 1402 in the case where the application amount of the color material inks is less than the threshold 1403 matches the relationship between the application amount of the color material inks and the application amount of the reaction liquid that is specified by the line 1401.

In the case where the application amount of the color material inks is greater than the threshold 1403, the application amount of the reaction liquid is increased to twice the relationship between the application amount of the color material inks and the application amount of the reaction liquid that is specified by the line 1401, at the maximum value of the application amount of the color material inks. In other words, in regions where the application amount of the color material inks is greater than the threshold 1403 and up to the maximum value of the application amount of the color material inks, the application amount of the reaction liquid specified by the line 1402 is gradually increased to one to two times the application amount of the reaction liquid specified by the line 1401.

On the other hand, for the recording medium in FIG. 13B, the relationship between the application amount of the color material inks and the application amount of the reaction liquid that is specified by a line 1404 is used in the case where the lamination processing mode is not set. Although the recording medium type differs, the application amount of the reaction liquid specified by the line 1404 may be the same as or different from the line 1401. It is sufficient for the application amount of the reaction liquid to be greater than or equal to the amount that is sufficient to reduce at least bleeding and beading with respect to the application amount of the color material inks. On the other hand, in the case where the lamination processing mode is set, the relationship between the application amount of the color material inks and the application amount of the reaction liquid that is specified by a line 1405 is used.

In regions where the application amount of the color material inks is greater than a threshold 1406, the application amount of the reaction liquid is increased relative to the line 1404. In regions where the application amount of the color material inks is less than the threshold 1406, the application amount of the reaction liquid is also increased relative to the line 1404. The rate of increase in the application amount of the reaction liquid based on whether the lamination processing mode is set is set lower in regions with a small application amount of the color material inks than in regions with a large application amount of the color material inks. As described above, because the adhesion to the laminate layer often becomes an issue also in regions with a small application amount of the color material inks on the recording medium illustrated in FIG. 13B, the application amount of the reaction liquid is increased. On the other hand, the rate of increase in the application amount of the reaction liquid is set low due to the first factor that the application amount of the lubricant that may act as an adhesion inhibiting factor is small.

In the present exemplary embodiment, the application amount of the reaction liquid specified by the line 1405 is increased to 1.5 times the line 1404 in the case where the application amount of the color material inks is less than the threshold 1406. In the case where the application amount of the color material inks is greater than the threshold 1406, the application amount of the reaction liquid is increased to twice the application amount of the reaction liquid specified by the line 1404, at the maximum value of the application amount of the color material inks. In other words, in regions where the application amount of the color material inks is greater than the threshold 1406 and up to the maximum value of the application amount of the color material inks, the application amount of the reaction liquid specified by the line 1405 is gradually increased to 1.5 to 2 times the application amount of the reaction liquid specified by the line 1404.

The regions with a small application amount of the color material inks refer to regions in the recorded product with many blank regions, whereas the regions with a large application amount of the color material inks refer to regions in the recorded product with few blank regions. In the present exemplary embodiment, the recorded product is observed under an optical microscope, and the occupancy rate of non-recorded regions is calculated for each region. Then, in a case where the occupancy rate of non-recorded regions within a region is 10% or higher, the region is determined as a region with a small application amount of the color material inks. On the other hand, in a case where the occupancy rate of non-recorded regions within a region is less than 10%, the region is determined as a region with a large application amount of the color material inks.

The threshold 1403 for the application amount of the color material inks on a recording medium of a type reducing wetting and spreading properties of isolated dots of the color material inks is greater than the threshold 1406 for the application amount of the color material inks on the recording medium P increasing wetting and spreading properties of isolated dots of the color material inks. While the occupancy rate of non-recorded regions on the recorded product is set at 10% as a reference for the threshold for the application amount of the color material inks in the present exemplary embodiment, this is not a limitation.

### EXAMPLES

Examples will be described below.

### <Ink Composition>

Details of each ink of an ink set used in the Examples will be described below. Hereinafter, unless otherwise specified, “parts” and “%” are by mass.

### 1. Black Ink

### 1-1. Preparation of Black Dispersion Liquid

First, an anionic polymer P-1 [styrene/butyl acrylate/acrylic acid copolymer (polymerization ratio (weight ratio)=30/40/30), acid value 202, weight average molecular weight 6500] was prepared. This was neutralized with a potassium hydroxide aqueous solution and diluted with ion-exchanged water to prepare a homogeneous 10% by mass polymer solution.

Six hundred grams of the polymer solution, 100 g of carbon black, and 300 g of ion-exchanged water were mixed and mechanically stirred for a predetermined time. Thereafter, undispersed materials containing coarse particles were removed by a centrifugal separation process to obtain a black dispersion liquid. The obtained black dispersion liquid had a pigment concentration of 10% by mass.

### 1-2. Preparation of Fine Resin Particle Dispersion Liquid

First, the following three additive liquids were gradually added, drop by drop, while being heated to 70° C. under a nitrogen atmosphere and stirred with a motor, and polymerization was conducted for five hours. The additive liquids are a hydrophobic monomer consisting of 28.5 parts of methyl methacrylate, a mixed solution containing a hydrophilic monomer consisting of 4.3 parts of sodium p-styrenesulfonate and 30 parts of water, and a mixed solution containing a polymerization initiator consisting of 0.05 parts of potassium persulfate and 30 parts of water. The glass transition temperature of the fine resin particles was 60° C.

### 1-3. Preparation of Black Ink

Black ink was prepared using the black dispersion liquid described above, and components described below were added to the black ink to adjust the concentration to a predetermined concentration. Thereafter, the components were sufficiently mixed and stirred and then filtered through a microfilter (manufactured by FUJIFILM Corporation) with a pore size of 2.5 μm under applied pressure to prepare a pigment ink with a pigment concentration of 2% by mass.

| | | |
|---|---|---|
| Black dispersion liquid described above | 20 | parts |
| Water-soluble resin emulsion dispersion | 4 | parts |
| liquid described above | | |
| Wax particles | 3 | parts |
| Zonyl FSO-100 (fluorine-based surfactant | 0.05 | parts |
| manufactured by DuPont) | | |
| 1,2-Butanediol | 15 | parts |
| Acetylene glycol EO adduct (manufactured | 0.5 | parts |
| by Kawaken Fine Chemicals Co., Ltd.) | | |

| | |
|---|---|
| Ion-exchanged water (manufactured by | the remainder |
| Kawaken Fine Chemicals Co., Ltd.) | |

### 2. Reaction Liquid

A reaction liquid used in the Examples contained a reagent that reacts with the pigments contained in the inks and causes the pigments to aggregate or gel. In the Examples, a polyvalent metal salt, specifically magnesium sulfate heptahydrate, was used as a reagent. An example of a reagent is not limited to magnesium sulfate heptahydrate, and various organic acids and polyvalent metal salts that are water-soluble may be used as a reagent in the reaction liquid in the Examples. The content of the organic acid or polyvalent metal salt is preferably 0.1% by mass or more and 90.0% by mass or less, more preferably 1.0% by mass or more and 70.0% by mass or less, based on the total mass of the composition contained in the reaction liquid.

### 2-1. Preparation of Reaction Liquid

In the Examples, magnesium sulfate heptahydrate was used, and the following components were mixed to prepare a reaction liquid, as described above.

| | | |
|---|---|---|
| Magnesium sulfate heptahydrate | 4 | parts |
| 1,2-Butanediol | 10 | parts |
| Acetylene glycol EO adduct | 0.5 | parts |

| | |
|---|---|
| Ion-exchanged water (manufactured | the remainder |
| by Kawaken Fine Chemicals Co., Ltd.) | |

### <Recording Medium>

One of the recording media P with low absorbency in the Examples has the characteristic that non-recorded regions have smooth surface properties and wetting and spreading properties of the isolated dots 1301 of the color material inks are reduced, as illustrated in FIG. 13A. Specifically, a Scotchcal graphic film (IJ 1220-10), which is an adhesive-backed polyvinyl chloride film manufactured by 3M, was used as a recording medium P (type A).

Another one of the low-absorbency recording media in the Examples has the characteristic that non-recorded regions have smooth surface properties and wetting and spreading properties of the isolated dots 1301 of the color material inks are increased, as illustrated in FIG. 13B. Specifically, a high-tack strong adhesive general-purpose inkjet medium (MPI 1106), which is an adhesive-backed polyvinyl chloride film manufactured by Avery Dennison, was used as a recording medium P (type B).

### <Lamination Processing>

In the Examples, a Scotchcal overlaminate film (IJ 4132), which is a cold laminate film manufactured by 3M, was used as a laminate film. The laminate film is a 3M-recommended laminate film provided for the recording medium P (IJ1 220-10) of type A used in the Examples and has a laminate film thickness of 100 nm (including adhesive).

Further, a laminator (Titan 165) manufactured by CBC Co., Ltd. was used as a lamination processing apparatus in the Examples. The lamination processing temperature was set to 30° C. for both the upper and lower main rollers, and setting 1 was selected to set the lamination processing speed to approximately 7 mm per second. Further, the gap setting for the upper and lower main rollers was set to 1.5 mil (approximately 38.1 um).

### <Method for Evaluating Adhesion to Laminate Layer>

In the Examples, a peel analyzer (VPA-3) manufactured by Kyowa Interface Science Co., Ltd. was used as a peel strength measurement apparatus for quantifying the adhesion between a surface layer of an ink layer on a recorded product and a laminate layer. A recorded product that underwent lamination processing and was left for 24 hours was then bonded to a stainless steel plate, and the peel strength was measured at a peel angle of 180° and a peel speed of 30 mm per minute. Criteria for evaluating adhesion are as follows.

### Laminate Adhesion Evaluation: Excellent

The adhesion strength between the surface layer of the ink layer on the recorded product and the laminate layer is high and comparable to the adhesion strength between the non-recorded regions (white portions) of the recording medium P and the recommended laminate film.

### Laminate Adhesion Evaluation: Good

The adhesion strength between the surface layer of the ink layer on the recorded product and the laminate layer is high but slightly inferior to the adhesion strength between the non-recorded regions (white portions) of the recording medium P and the recommended laminate film. It should be noted that bending the recorded product having undergone lamination processing does not cause the laminate layer to peel off.

### Laminate Adhesion Evaluation: Poor

The adhesion between the surface layer of the ink layer on the recorded product and the laminate layer is low.

Bending the recorded product having undergone lamination processing may partially peel off the laminate layer at an end portion of the recorded product.

### <Evaluation of Fastness of Ink Layer Before Lamination Processing>

In the Examples, abrasion resistance evaluation was performed using a GAKUSHIN rubbing tester (compliant with Japanese Industrial Standard (JIS) L0849) to quantify the fastness of the ink layer on the recorded product before lamination processing in the case where the lamination processing mode was set. The recorded product was placed on a curved test stage of the GAKUSHIN rubbing tester and brought into contact with a rubbing head weighing 500 g. Here, a white cloth for rubbing (grade 3 cotton specified in JIS L0805) was attached to the rubbing head. In this state, the stage was reciprocated 50 times horizontally at a constant speed while a load was applied, and then the wear condition of the ink layer on the recorded product was evaluated. Criteria for evaluating fastness are as follows.

### Fastness Evaluation: Excellent

There is hardly any change in the ink layer on the recorded product. Further, even upon close observation, it is unclear whether the color materials have been transferred to the white cloth for rubbing.

### Fastness Evaluation: Good

Some scratches are visible on the ink layer on the recorded product. Further, the transfer of the color materials to the white cloth for rubbing is very minimal but noticeable upon close observation.

### Fastness Evaluation: Poor

Scratches are visible on the ink layer on the recorded product. Further, the transfer of the color materials to the white cloth for rubbing is immediately noticeable.

### Example 1

A case where the recording medium is of type A and the lamination processing mode is set. In order to achieve the relationship between the application amount of the color material inks and the application amount of the reaction liquid that is specified by the line 1102 in FIG. 11, the application amount of the reaction liquid relative to 100% of the application amount of the color material inks was doubled to 37.5% (=18.8%+18.7%).

### Example 2

A case where the recording medium is of type B and the lamination processing mode is set. In order to achieve the relationship between the application amount of the color material inks and the application amount of the reaction liquid that is specified by the line 1102 in FIG. 11, the application amount of the reaction liquid relative to 100% of the application amount of the color material inks was doubled to 37.5% (=18.8%+18.7%).

### Example 3

A case where the recording medium is of type A and the lamination processing mode is set. In order to achieve the relationship between the application amount of the color material inks and the application amount of the reaction liquid that is specified by the line 1102 in FIG. 11, the application amount of the reaction liquid relative to 33% of the application amount of the color material inks was doubled to 12.5% (=6.3%+6.2%).

### Example 4

A case where the recording medium is of type B and the lamination processing mode is set. In order to achieve the relationship between the application amount of the color material inks and the application amount of the reaction liquid that is specified by the line 1102 in FIG. 11, the application amount of the reaction liquid relative to 33% of the application amount of the color material inks was doubled to 12.5% (=6.3%+6.2%).

### Example 5

A case where the recording medium is of type A, the lamination processing mode is set, and the application amount of the color material inks is less than the threshold 1403. In order to achieve the relationship between the application amount of the color material inks and the application amount of the reaction liquid that is specified by the line 1402 in FIG. 14A, the application amount of the reaction liquid relative to 33% of the application amount of the color material inks was adjusted to 6.3% (=6.3%+0%), similarly to the relationship between the application amount of the color material inks and the application amount of the reaction liquid that is specified by the line 1401.

### Example 6

A case where the recording medium is of type B, the lamination processing mode is set, and the application amount of the color material inks is less than the threshold 1406. In order to achieve the relationship between the application amount of the color material inks and the application amount of the reaction liquid that is specified by the line 1405 in FIG. 14B, the application amount of the reaction liquid relative to 33% of the application amount of the color material inks was increased by 1.5 times to 9.4% (=6.3%+3.1%).

### Comparative Example 1

A case where the recording medium is of type A and the lamination processing mode is set. In order to achieve the relationship between the application amount of the color material inks and the application amount of the reaction liquid that is specified by the line 1101 in FIG. 11, the application amount of the reaction liquid relative to 100% of the application amount of the color material inks was adjusted to 18.8%.

### Comparative Example 2

A case where the recording medium is of type B and the lamination processing mode is set. In order to achieve the relationship between the application amount of the color material inks and the application amount of the reaction liquid that is specified by the line 1101 in FIG. 11, the application amount of the reaction liquid relative to 100% of the application amount of the color material inks was adjusted to 18.8%.

### Comparative Example 3

A case where the recording medium is of type B, the lamination processing mode is set, and the application amount of the color material inks is less than the threshold 1406. In order to achieve the relationship between the application amount of the color material inks and the application amount of the reaction liquid on the recording medium (type A) that is specified by the line 1402 in FIG. 14A, the application amount of the reaction liquid relative to 33% of the application amount of the color material inks was adjusted to 6.3% (=6.3%+0%), similarly to the relationship between the application amount of the color material inks and the application amount of the reaction liquid that is specified by the line 1401.

TABLE 1

| | | | | Reaction Liquid | | | |
|---|---|---|---|---|---|---|---|
| | | | | Application Amount | | | |
| | | | | Final | | | |
| | | | Color | Reaction | Increase | | Fastness |
| | | | Material Ink | Liquid | In | | Before |
| | Recording Medium | | Application | Application | Reaction | Laminate | Lamination |
| | Type | Characteristic | Amount | Amount | Liquid | Adhesion | Processing |
| Example 1 | A | Reduce Wetting | 100% | 37.5% | 18.7% | Excellent | Good |
| | | and Spreading | | | | | |
| | | Property | | | | | |
| Example 2 | B | Increase | 100% | 37.5% | 18.7% | Excellent | Good |
| | | Wetting and | | | | | |
| | | Spreading | | | | | |
| | | Property | | | | | |
| Example 3 | A | Reduce Wetting | 33% | 12.5% | 6.2% | Excellent | Good |
| | | and Spreading | | | | | |
| | | Property | | | | | |
| Example 4 | B | Increase | 33% | 12.5% | 6.2% | Excellent | Good |
| | | Wetting and | | | | | |
| | | Spreading | | | | | |
| | | Property | | | | | |
| Example 5 | A | Reduce Wetting | 33% | 6.3% | 0.0% | Excellent | Excellent |
| | | and Spreading | | | | | |
| | | Property | | | | | |
| Example 6 | B | Increase | 33% | 9.4% | 3.1% | Excellent | Excellent |
| | | Wetting and | | | | | |
| | | Spreading | | | | | |
| | | Property | | | | | |
| Comparative | A | Reduce Wetting | 100% | 18.8% | 0.0% | Good | Excellent |
| Example 1 | | and Spreading | | | | | |
| | | Property | | | | | |
| Comparative | B | Increase | 100% | 18.8% | 0.0% | Good | Excellent |
| Example 2 | | Wetting and | | | | | |
| | | Spreading | | | | | |
| | | Property | | | | | |
| Comparative | B | Increase | 33% | 6.3% | 0.0% | Good | Excellent |
| Example 3 | | Wetting and | | | | | |
| | | Spreading | | | | | |
| | | Property | | | | | |

In Example 1, the application amount of the reaction liquid was increased beyond the amount sufficient for reducing bleeding. As a result, the laminate adhesion was improved in comparison to Comparative Example 1. The evaluation was rated “Excellent”. The increase in the amount of the reagent 81 in the ink layer led to a decrease in the proportion of the lubricant 82 present on the surface layer of the ink layer as illustrated in FIG. 8B, causing the lubricant 82 to sink into the ink layer. This is considered to have reduced the inhibiting factor that reduces adhesion of the surface layer of the ink layer to the laminate layer. If the proportion of the lubricant that should be present on the surface layer of the ink layer is decreased to enhance the slipperiness of the surface layer of the ink layer on the recorded product, the fastness before lamination processing may decrease. However, it is sufficient to maintain the fastness until lamination processing is performed, and it is considered to be at a level that should not cause any issues in actual use.

In Example 2, the recording medium P was of type B. As in Example 1, the laminate adhesion evaluation was rated “Excellent”. The fastness before lamination processing decreased compared to Comparative Example 2 but remained at a level that should not cause any issues in actual use.

In Example 3, the recording medium P was of type A, and the application amount of the color material inks was less than that in Example 1. As a result of increasing the application amount of the reaction liquid beyond the amount sufficient for reducing bleeding, the laminate adhesion evaluation was rated “Excellent”, and the evaluation of the fastness before lamination processing was rated “Good”.

In Example 4, the recording medium P was of type B. As in Example 3, the laminate adhesion evaluation was rated “Excellent”, and the evaluation of the fastness before lamination processing was rated “Good”.

In Example 5, the recording medium P was of type A, and the application amount of the color material inks was less than that in Example 1. The application amount of the reagent was not increased beyond the amount sufficient for reducing bleeding, but the laminate adhesion evaluation was rated “Excellent”. This is because the recording medium P was of type A and the contribution of the non-recorded regions with high adhesion to the laminate layer was significant as illustrated in FIG. 13A. Since the application amount of the reaction liquid was not increased, the fastness before lamination processing did not decrease, and the evaluation was rated “Excellent”.

In Example 6, the recording medium P was of type B. The application amount of the reaction liquid was increased by 3.1% in comparison to Example 4. As a result, as in Example 4, the laminate adhesion evaluation was rated “Excellent”. By halving the increase in the application amount of the reaction liquid, the fastness before lamination processing did not decrease, and the evaluation was rated “Excellent”.

On the other hand, as in Comparative Example 3, in a case where the recording medium P was of type B, and the application amount of the color material inks was less than that in Example 2, the application amount of the reaction liquid was not increased beyond the amount sufficient for reducing bleeding. The laminate adhesion evaluation was rated “Good”, and no improvements were made. This is because the recording medium P was of type B and the contribution of the non-recorded regions with high adhesion to the laminate layer was insignificant as illustrated in FIG. 13B. Since the application amount of the reaction liquid was not increased, the fastness before lamination processing did not decrease, and the evaluation was rated “Excellent”.

### Other Exemplary Embodiments

While the reaction solution in the above-described exemplary embodiments do not contain any colorant, it may contain a small amount of colorant as long as it does not affect the image quality. Even in a case where a slight amount of colorant is contained within the range that does not affect the image quality, it is also included in the expression “does not contain any colorant.

While the above-described exemplary embodiments describe an inkjet recording apparatus and a recording method using the inkjet recording apparatus, they are also applicable to an image processing apparatus or an image processing method that generates data for performing the recording methods described in each of the exemplary embodiments. Furthermore, the exemplary embodiments are each applicable to a form in which a program for executing the recording methods described in each of the exemplary embodiments is provided separately from the recording apparatus.

In addition to thermal jet-type inkjet recording apparatuses, the present disclosure is applicable to various image recording apparatuses, such as so-called piezo-type inkjet recording apparatuses that eject ink using piezoelectric elements. Although the above-described exemplary embodiments describe serial-type inkjet printers as examples, the disclosure is not limited to these and may also be applied to recording apparatuses having line heads with colors disposed along the sheet conveyance direction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-065813, filed Apr. 15, 2024, which is hereby incorporated by reference herein in its entirety.

What is claimed is:

1. A recording apparatus comprising:
a recording unit including a plurality of recording elements configured to apply a color material ink containing a color material to a recording medium and a plurality of recording elements configured to apply, to the recording medium, a reaction liquid containing a component that causes the color material contained in the color material ink to aggregate;
a controlling unit configured to control an operation of applying the color material ink and the reaction liquid by the recording unit;
an acquiring unit configured to acquire information indicating whether to perform lamination processing on the recording medium on which an image has been recorded; and
a determining unit configured to determine an application amount of the reaction liquid based on the information and an application amount of the color material ink for each pixel.

2. The recording apparatus according to claim 1, wherein the application amount of the reaction liquid determined by the determining unit is greater in a case where the information indicates that lamination processing is to be performed than in a case where the information indicates that lamination processing is not to be performed.

3. The recording apparatus according to claim 1, wherein a first ratio is less than a second ratio,
where the application amount of the color material ink is a first amount, and the first ratio is a ratio between the application amount of the reaction liquid determined by the determining unit in a case where the information indicates that lamination processing is to be performed and the application amount of the reaction liquid determined by the determining unit in a case where the information indicates that lamination processing is not to be performed, and
where the application amount of the color material ink is a second amount greater than the first amount, and the second ratio is a ratio between the application amount of the reaction liquid determined by the determining unit in a case where the information indicates that lamination processing is to be performed and the application amount of the reaction liquid determined by the determining unit in a case where the information indicates that lamination processing is not to be performed.

4. The recording apparatus according to claim 1, wherein the color material ink contains a water-soluble resin emulsion and a lubricant.

5. The recording apparatus according to claim 4, wherein the lubricant contained in the color material ink is a wax particle, a silicone-based surfactant, or a fluorine-based surfactant.

6. The recording apparatus according to claim 1, wherein the recording medium is a recording medium with low absorbency.

7. A recording apparatus comprising:
a recording unit including a plurality of recording elements configured to apply a color material ink containing a color material to a recording medium and a plurality of recording elements configured to apply, to the recording medium, a reaction liquid containing a component that causes the color material contained in the color material ink to aggregate;
an acquiring unit configured to acquire information indicating whether to perform lamination processing on the recording medium on which an image has been recorded;
a determining unit configured to determine an application amount of the reaction liquid based on the information and an application amount of the color material ink for each pixel; and
a controlling unit configured to control, based on determination determined by the determining unit, an operation of applying the color material ink and the reaction liquid.

8. An image processing method comprising:
acquiring information indicating whether to perform lamination processing on a recording medium on which an image has been recorded; and
determining, based on the information and an application amount of a color material ink containing a color material for each pixel, an application amount of a reaction liquid containing a component that causes the color material contained in the color material ink to aggregate.

9. A non-transitory computer-readable storage medium storing instruction when executed cause a computer to execute a image processing method for a recording apparatus, the method comprising:
acquiring information indicating whether to perform lamination processing on a recording medium on which an image has been recorded; and
determining, based on the information and an application amount of a color material ink containing a color material for each pixel, an application amount of a reaction liquid containing a component that causes the color material contained in the color material ink to aggregate.
